(19) United States
(12) Patent Application Publication
(10) Pub. No.: US 2004/0105633 A1
(43) Pub. Date: Jun. 3, 2004

(54) Optical module

(75) Inventors: Manabu Ishikawa, Yokohama-shi (JP); Kazushige Oki, Yokohama-shi (JP)

Correspondence Address: MCDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/669,098

(22) Filed: Sep. 24, 2003

(30) Foreign Application Priority Data
Sep. 27, 2002 (JP) 2002-284065

(51) Int. Cl. G02B 6/36

(52) U.S. Cl. 385/92

(57) ABSTRACT

An optical module having an improved thermal condition around a light-emitting device is provided. The optical module includes the light-emitting device, a substrate on which a driver circuits connected to the converting device is mounted thereon, a base for securing the substrate and the light-emitting device, a thermal block for dissipating heat generated by the driver circuits, and a cover. The base has an opening into which the thermal block is arranged so as to be in contact with the driver circuits, whereby heat generated by the circuits enables to transmit to the cover through the thermal block.

This application relates to prior applications filed by the same aassignee,

U.S. Pat. No. 6,600,611 issued Jul. 29, 2003, filed Mar. 25, 2002, titled “Optical Module”;

United States Patent Application Number 20030063424A filed Mar. 25, 2002, titled “Optical Module”; United States Patent Application Number 20020154362A filed Mar. 26, 2002, titled “Optical Link Module”; and

U.S. patent Ser. No. 10/378,660 filed Mar. 5, 2003, titled “Optical Link Module”.

### BACKGROUND OF THE INVENTION

1. Field of the Invention

This invention relates to an optical module, especially an optical module with a small form-factor hot-pluggable (SFP) module.

2. Related Prior Art

Optical modules are widely used in an optical data link and an optical communication system such as an optical local area network (optical LAN). A conventional optical module having such hot-pluggable function comprises a housing and a substrate provided in the housing. On the substrate, an optical subassembly such as a transmitting-assembly and a receiving-assembly, and some electrical parts containing a circuit for driving the transmitting subassembly are mounted. Such configuration of the conventional optical module is shown in applications listed in the beginning of the specification and also in U.S. Pat. No. 6,335,869.

A light-emitting semiconductor device, such as a laser diode, contained in the subassembly, is strongly affected by temperature. Namely, the device has a strong dependence on the temperature. Therefore, it is necessary for keeping the performance of the laser diode to suppress the increase of the temperature therearound.

### SUMMARY OF THE INVENTION

One aspect of the present invention is to provide an optical module in which a thermal condition around the laser diode may be improved.

According to the present invention, an optical module comprises an optical subassembly, a substrate, a base, a metal cover and a thermal block. The optical subassembly includes a light-emitting semiconductor device such as laser diode. The substrate secures the optical subassembly and mounts a circuit for driving the laser diode, the circuit generates an amount of heat. The base encloses the optical subassembly and the substrate. The base has an opening to expose the circuit on the substrate to the outside. The thermal block, preferably made of metal, is arranged so as to lid the opening of the base and thermally in contact with the circuit and the cover.

In this configuration, since the thermal block is in thermally contact with the circuit on the substrate and also with the cover, heat generated by the circuit is effectively conducted to the cover and dissipated to the outside of the module.

The thermal block is arranged so as to partition the inner space of the base. The optical subassembly is installed in one space and the circuit on the substrate is installed in the other space. Therefore, the optical subassembly is electrically isolated from the circuit, thereby enhances an electromagnetic interference (EMI) characteristics of the optical module.

The optical module may further comprise a thermal sheet preferably made of insulator between the thermal block and the circuit. The thermal sheet is pressed to the circuit when the thermal block is installed into the opening of the base and the base is enclosed into the cover. Therefore, the heat generated by the circuit is effectively conducted to the cover through the thermal sheet and the thermal block, and dissipated to the outside of the module.

The optical module of the present invention may comprise further thermal sheet between the cover and the optical subassembly. Therefore, the optical subassembly is thermally in contact with the cover through the further thermal sheet, whereby heat generated by the optical subassembly is effectively conducted to the cover and is dissipated to the outside of the module.

### BRIEF DESCRIPTION OF DRAWINGS

FIG. 1 shows cages into which an optical module is inserted and a host-board where the cage is mounted;

FIG. 2 is an exploded view of the optical module; and

FIG. 3 is a cross sectional view of the optical module.

### DETAILED DESCRIPTION OF PREFERRED EMBODIMENT

Preferred embodiments will be described as referring to accompanying figures. Elements identical to each other will be referred to with numerals identical to each other without overlapping explanations.

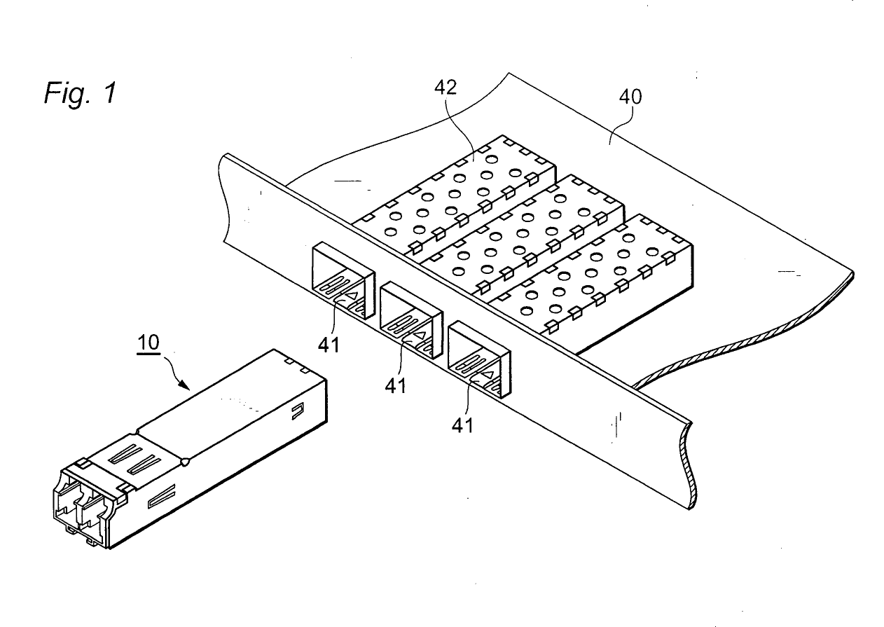

FIG. 1 is a perspective view of cages on a host board, into which an optical module of the present embodiment will be inserted. A projection provided in the optical module 10, which is not shown in FIG. 1, latches the hook provided in the cage on the board 40, thereby the module is fixed to the board 40.

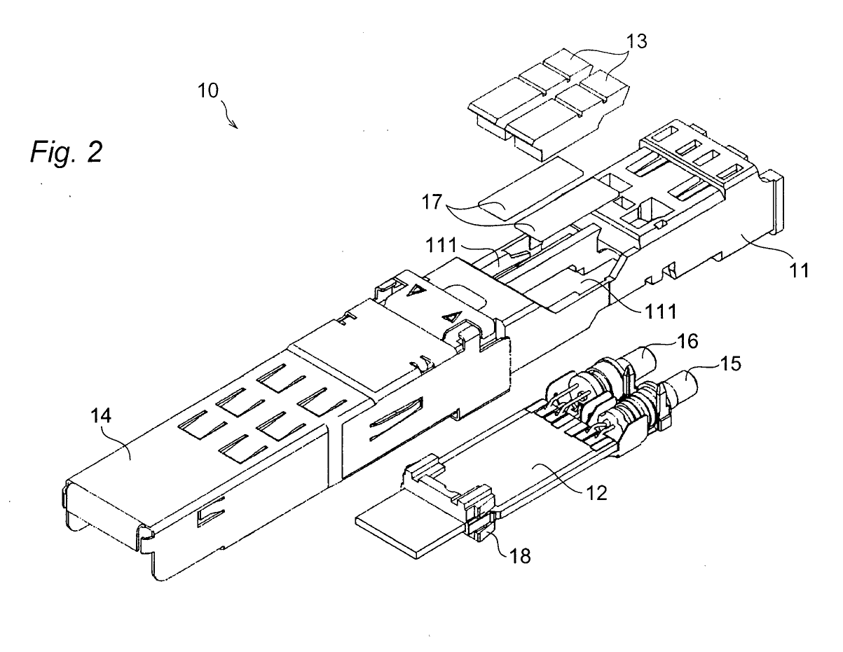

FIG. 2 is an exploded view of the optical module 10. The module 10 comprises a base 11, a substrate 12, a plurality of thermal blocks 13, a cover 14, a transmitting optical subassembly (hereafter denoted by TOSA) 15, a receiving optical subassembly (hereafter denoted by ROSA) 16, a thermal sheet 17 and a stopper 18. The base 11 encloses the TOSA 15, the ROSA 16 and the substrate 12 and has an opening 111 into which the TOSA 15 and the ROSA 16 are installed. The base is formed by resin molding.

The substrate installs a plurality of electronic parts thereon. In the present embodiment, a primary surface of the substrate 12 mounts a circuit for driving a laser diode including in the TOSA and the substrate 12 is installed so that the primary surface thereof faces the base 11. The TOSA 15 and the ROSA are mounted on the substrate by a plurality of bracket 27 and lead terminals 28. The stopper 18 fit to the substrate 12 supports the substrate 12 by arranging between the base 11 and the cover 14.

Thermal blocks 13 and thermal sheets 17 made of resin such as silicone is arranged into the opening 111 of the base 11. The thermal block may be made of aluminum, aluminum alloy, copper or copper alloy. The thermal sheet 17 and the thermal block 13 are sandwiched and held between the base 11 and the cover 14. FIG. 13 is a cross sectional view taken along a major direction of the optical module thus assembled.

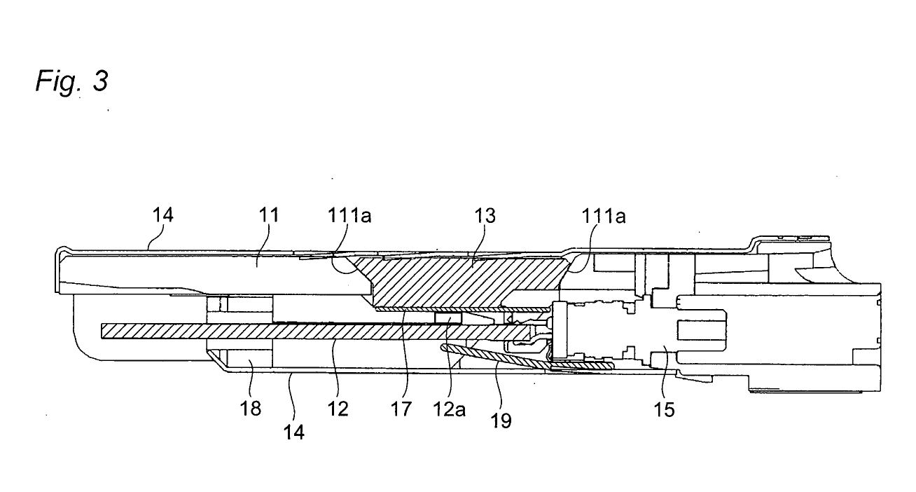

As shown in FIG. 3, the substrate 12 is fit into the stopper 18 and secured in the base 11 by holding the stopper 18 between the base 11 and the cover 14. On the primary surface of the substrate 12, some electrical parts including the driver circuit 12a are mount and the thermal sheet 17 is arranged so as to come in contact with the driver circuit 12a.

The thermal sheet 17 is pressed to the driver circuit 12a by the thermal block 13 that is pressed by the cover 14. The thermal block is arranged so as to cover the opening 111 of the base 11. An inner surface 111a of the opening has a slope from the cover 14 to the substrate 12. The thermal block is secured by pressing the outer surface thereof to the slope of the inner surface 111a of the opening.

The thermal block thermally comes in contact with the driving circuit 12a through the thermal sheet 17 and is mechanically in contact with the cover 14. Therefore, heat generated by the driving circuit 12a is transmitted to the cover 14 through the thermal sheet 17 and the thermal block 13.

The cover 14 encloses the thermal block 13, the thermal sheet, the substrate and the base. Another thermal sheet 19 is secured between the cover and the TOSA 15, whereby heat generated by the TOSA is effectively dissipated to the cover 14.

The opening 111 is formed nearly center of the base, which corresponds to an edge of the substrate 12 connected to the TOSA. Therefore, the thermal block 13 partitions a space within the optical module 11. The thermal block 13 is made of metal as previously described, thereby electrically isolates the space in the optical module 11.

In the present configuration described above, since the thermal block 13 is arranged so as to come in contact with the inner surface 11a of the opening 11 and heat generated by the driving circuit 12a is effectively dissipated to the cover through the thermal sheet 17 and the thermal block, the temperature within the optical module may be decreased about 10 degrees centigrade or more.

Moreover, since the thermal block 13 is made of metal and partitions the inner space of the base 11, which electrically isolates the inner space thereof, the electromagnetic interference (EMI) may be enhanced. In the present configuration, emissive noise between 2 GHz to 4 GHz may be suppressed. Since the thermal block 13 comes in contact with the driving circuit 12a through the thermal sheet 17, heat generated by the driving circuit 12a is effectively dissipated to the out side of the module 10 through the thermal sheet 17, the thermal block 13 and the cover 14.

Furthermore, since the TOSA 15 comes in contact with another thermal sheet 19 that is in contact with the cover 14, heat generated by the TOSA is conducted to the cover 14 through the thermal sheet 19, thereby dissipated to the outside of the optical module 10.

What is claimed is:

1. An optical module, comprising:
an optical subassembly including a semiconductor optical device;
a substrate securing the optical subassembly and mounting a circuit for driving the semiconductor optical device, the circuit generating heat;
a base enclosing the optical subassembly, the base providing an opening for exposing the circuit;
a cover made of metal; and
a thermal block for dissipating the heat generated by the circuit, the thermal block arranged so as to lid the opening of the base and being thermally in contact with the circuit and the cover.

2. The optical module according to claim 1, wherein the thermal block is made of metal and partitions an inner space of the base.

3. The optical module according to claim 1, further comprises a thermal sheet between the thermal block and the circuit.

4. The optical module according to claim 3, wherein the thermal sheet is made of insulator.

5. The optical module according to claim 1, further comprising a thermal sheet between the cover and the optical subassembly, the optical subassembly being thermally in contact with the cover through the thermal sheet.

6. The optical module according to claim 5, wherein the thermal sheet is made of insulator.
